(19) United States
(12) Patent Application Publication
(10) Pub. No.: US 2026/0291771 A1
(43) Pub. Date: Sep. 24, 2026

(54) IN-VEHICLE APPARATUS, SETTING PROCESSING METHOD, AND SETTING PROCESSING PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Norihiro ONO, Osaka-shi, Osaka (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/471,805

(22) PCT Filed: Mar. 15, 2024
(86) PCT No.: PCT/JP2024/010148

§ 371 Date: Oct. 2, 2025

(30) Foreign Application Priority Data
Apr. 3, 2023 (JP) 2023-059955

(51) Int. Cl. H04L 12/40; H04L 41/0806

(52) U.S. Cl. CPC H04L 12/40; H04L 41/0806; H04L 2012/40273

(57) ABSTRACT

An in-vehicle apparatus for use in an in-vehicle network includes: an acquisition unit configured to acquire vehicle information relating to a vehicle in which the in-vehicle apparatus is installed from a communication line in the in-vehicle network; and a setting processing unit configured to perform setting processing that allows the in-vehicle apparatus to communicate with another device via the communication line using setting information based on the vehicle information acquired by the acquisition unit.

### CROSS-REFERENCE TO RELATED APPLICATIONS

This application is the U.S. national stage of PCT/JP2024/010148 filed on Mar. 15, 2024, which claims priority of Japanese Patent Application No. JP 2023-059955 filed on Apr. 3, 2023, the contents of which are incorporated herein.

### TECHNICAL FIELD

The present disclosure relates to an in-vehicle apparatus, a setting processing method, and a setting processing program.

### BACKGROUND

JP 2017-123060A discloses the following technology. That is, a vehicle information writing device includes: a terminal device capable of exchanging data with a vehicle; and an information center, and can mutually communicate with the terminal device and the information center. The terminal device includes: a position detection unit configured to detect a current position; and a vehicle type information acquisition unit configured to acquire vehicle type information that specifies the type of a setting target vehicle, and is configured to send, to the information center, a vehicle type setting information request including regional information reflecting the current position and the vehicle type information, and receive, from the information center, vehicle type setting information including setting parameters suitable for the regional information and applicable to an in-vehicle apparatus installed in the vehicle, in response to the vehicle type setting information request. The vehicle information writing device further includes: a vehicle setting information generation unit configured to generate vehicle setting information reflecting the received vehicle type setting information; and a vehicle setting information output unit configured to output the vehicle setting information to the vehicle.

Conventionally, systems have been developed that includes a management apparatus that collects, from a vehicle, vehicle information relating to the vehicle.

### SUMMARY

An in-vehicle apparatus according to the present disclosure is directed to an in-vehicle apparatus for use in an in-vehicle network, including: an acquisition unit configured to acquire vehicle information relating to a vehicle in which the in-vehicle apparatus is installed from a communication line in the in-vehicle network; and a setting processing unit configured to perform setting processing that allows the in-vehicle apparatus to communicate with another device via the communication line using setting information based on the vehicle information acquired by the acquisition unit.

An aspect of the present disclosure may be realized as not only an in-vehicle apparatus including such a characteristic processing unit, but also a semiconductor integrated circuit that realizes part or all of the in-vehicle apparatus, or may be realized as a system that includes the in-vehicle apparatus.

Vehicle information may be collected using an in-vehicle apparatus that is retrofitted after the vehicle has been shipped. There is a wide variety of vehicles to which an in-vehicle apparatus is retrofitted, and the communication interface and vehicle information often differ for each vehicle type, for example. In such cases, it is necessary to configure settings for the in-vehicle apparatus to acquire vehicle information before or after the in-vehicle apparatus is installed in the vehicle, resulting in complication of the operation.

The present disclosure has been made to solve the above-mentioned problem, and an object of the present disclosure is to provide an in-vehicle apparatus, a setting processing method, and a setting processing program that can easily acquire vehicle information on a vehicle in which the in-vehicle apparatus is installed.

### Advantageous Effects

According to the present disclosure, it is possible to easily acquire vehicle information on a vehicle in which the in-vehicle apparatus is installed.

### BRIEF DESCRIPTION OF DRAWINGS

FIG. 1 is a diagram illustrating an example of a configuration of a communication system according to a first embodiment of the present disclosure.

FIG. 2 is a diagram illustrating an example of a configuration of an in-vehicle apparatus according to the first embodiment of the present disclosure.

FIG. 3 is a diagram illustrating an example of a configuration of a server according to the first embodiment of the present disclosure.

FIG. 4 is a diagram illustrating an example of a correspondence table stored in the server according to the first embodiment of the present disclosure.

FIG. 5 is a diagram illustrating an example of bit assignment information stored in the server according to the first embodiment of the present disclosure.

FIG. 6 is a diagram illustrating another example of bit assignment information stored in the server according to the first embodiment of the present disclosure.

FIG. 7 is a flowchart that defines an operation procedure when the in-vehicle apparatus according to the first embodiment of the present disclosure performs setting processing.

FIG. 8 is a flowchart that defines an operation procedure when the server according to the first embodiment of the present disclosure sends a setting instruction.

FIG. 9 is a diagram illustrating an example of a sequence of processes of the in-vehicle apparatus, the server, and an in-vehicle device in the communication system according to the first embodiment of the present disclosure.

FIG. 10 is a diagram illustrating an example of a configuration of an in-vehicle apparatus according to a second embodiment of the present disclosure.

FIG. 11 is a flowchart that defines an operation procedure when the in-vehicle apparatus according to the second embodiment of the present disclosure performs setting processing.

FIG. 12 is a diagram illustrating an example of a configuration of an in-vehicle apparatus according to a third embodiment of the present disclosure.

### DETAILED DESCRIPTION OF PREFERRED EMBODIMENTS

First, the content of embodiments of the present disclosure will be listed and described.

In a first aspect, an in-vehicle apparatus according to an embodiment of the present disclosure is directed to an in-vehicle apparatus for use in an in-vehicle network, including: an acquisition unit configured to acquire vehicle information relating to a vehicle in which the in-vehicle apparatus is installed from a communication line in the in-vehicle network; and a setting processing unit configured to perform setting processing that allows the in-vehicle apparatus to communicate with another device via the communication line using setting information based on the vehicle information acquired by the acquisition unit.

With this configuration, even if an in-vehicle apparatus is retrofitted after the vehicle has been shipped, the in-vehicle apparatus can perform the setting processing and automatically acquire vehicle information from another device, thus eliminating the need for prior setting of the in-vehicle apparatus by the vehicle user. Therefore, the vehicle information in the vehicle in which the in-vehicle apparatus is installed can be easily acquired.

In a second aspect according to the first aspect, the communication line may be a communication bus, and the acquisition unit may acquire the vehicle information output to the communication bus from an in-vehicle device connected to the communication bus.

With this configuration, the vehicle information necessary to perform the setting processing can be easily acquired from another device via the communication bus.

In a third aspect according to the first or the second aspect, the in-vehicle apparatus may further include: a communication unit configured to send the vehicle information acquired by the acquisition unit to a management apparatus located outside the vehicle, and receive the setting information from the management apparatus, wherein the setting processing unit may perform the setting processing based on the setting information received by the communication unit.

With this configuration, for example, it is no longer necessary to register the setting information for use in the setting processing of the in-vehicle apparatus in advance, thus saving storage capacity of the in-vehicle apparatus for storing various types of setting information.

In a fourth aspect according to any one of the first to the third aspects, prior to the setting processing, the setting processing unit may perform a trial to communicate with the other device via the communication line, and change settings of communication operation in the in-vehicle apparatus based on trial results of the trial until the trial results meet predetermined conditions, and the acquisition unit may communicate with the other device in accordance with the settings that correspond to a state where the trial results meet the predetermined conditions.

With this configuration, for example, even if the vehicle information necessary to perform the setting processing cannot be acquired in initial setting in the in-vehicle apparatus, the vehicle information can be reliably acquired from another device by performing a trial to communicate with the other device until information can be successfully received from the other device.

In a fifth aspect according to the first or the second aspect, the in-vehicle apparatus may further include: a creation unit configured to create the setting information that corresponds to the vehicle based on the vehicle information acquired by the acquisition unit.

With this configuration, the configuration in which setting information is created in the in-vehicle apparatus, for example, there is no need to communicate with devices outside the vehicle when performing the setting processing, thereby reducing the strain on the communication resources used by the vehicle in which the in-vehicle apparatus is installed.

In a sixth aspect according to any one of the first to the fifth aspects, the acquisition unit may be further configured to acquire transmission information sent in the communication line in accordance with the setting processing, and the in-vehicle apparatus may further include: a communication unit configured to send the transmission information acquired by the acquisition unit to an external apparatus located outside the vehicle.

With this configuration, when an in-vehicle apparatus for sending transmission information to devices outside the vehicle is retrofitted after the vehicle has been shipped, the transmission information can be provided to the devices outside the vehicle and used for analysis and the like.

In a seventh aspect, a setting processing method according to an embodiment of the present disclosure is directed to a setting processing method performed in an in-vehicle apparatus that is used in an in-vehicle network, including: a step of acquiring vehicle information relating to a vehicle in which the in-vehicle apparatus is installed from a communication line in the in-vehicle network; and a step of performing setting processing that allows the in-vehicle apparatus to communicate with another device via the communication line using setting information based on the acquired vehicle information.

With this configuration, even if an in-vehicle apparatus is retrofitted after the vehicle has been shipped, the in-vehicle apparatus can perform the setting processing and automatically acquire vehicle information from another device, thus eliminating the need for prior setting of the in-vehicle apparatus by the vehicle user. Therefore, the vehicle information in the vehicle in which the in-vehicle apparatus is installed can be easily acquired.

In an eighth aspect, a setting processing program according to an embodiment of the present disclosure is directed to a setting processing program for use in an in-vehicle apparatus that is used in an in-vehicle network, the program causing a computer to function as: an acquisition unit configured to acquire vehicle information relating to a vehicle in which the in-vehicle apparatus is installed from a communication line in the in-vehicle network; a setting processing unit configured to perform setting processing that allows the in-vehicle apparatus to communicate with another device via the communication line using setting information based on the vehicle information acquired by the acquisition unit.

With this configuration, even if an in-vehicle apparatus is retrofitted after the vehicle has been shipped, the in-vehicle apparatus can perform the setting processing and automatically acquire vehicle information from another device, thus eliminating the need for prior setting of the in-vehicle apparatus by the vehicle user. Therefore, the vehicle information in the vehicle in which the in-vehicle apparatus is installed can be easily acquired.

Hereinafter, embodiments of the present disclosure will be described with reference to the drawings. Note that the same reference numerals are given to the same or corresponding portions in the drawings, and description thereof will not be repeated. In addition, at least some of the embodiments described below can be combined as desired.

### First Embodiment

### Communication System

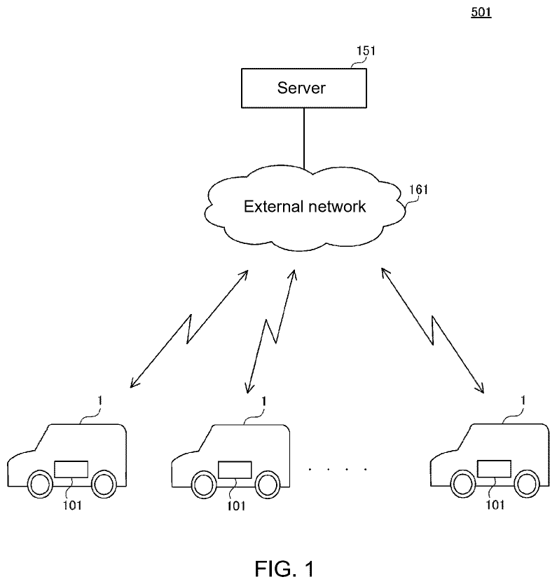

FIG. 1 is a diagram illustrating an example of a configuration of a communication system according to a first embodiment of the present disclosure. Referring to FIG. 1, a communication system 501 includes one or more in-vehicle apparatuses 101 and a server 151. Each of the in-vehicle apparatuses 101 and the server 151 can send and receive information via an external network 161 such as the Internet, for example. The in-vehicle apparatus 101 is installed in a vehicle 1. The server 151 is an example of a management apparatus provided outside the vehicle 1.

The server 151 is used, for example, by a business operator who manages the operation of the vehicle 1, or an individual.

### In-Vehicle Apparatus

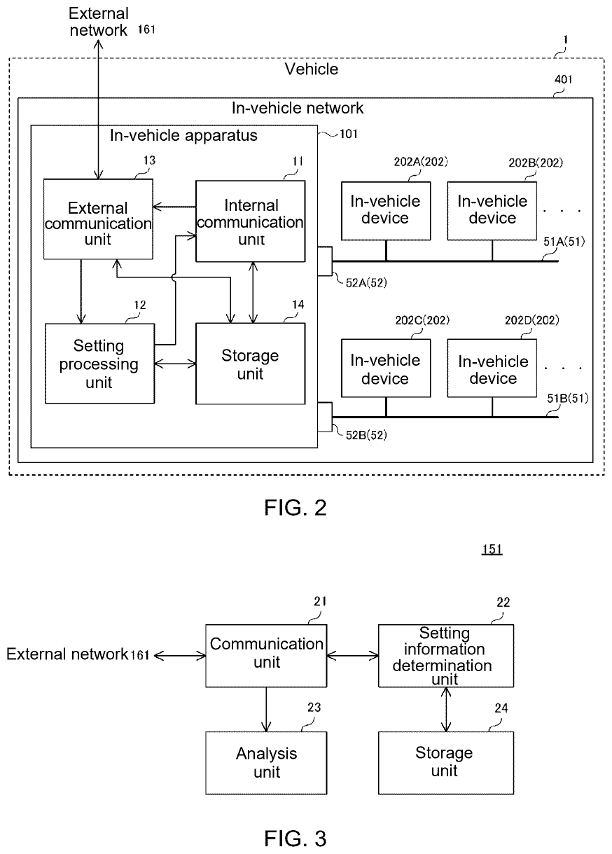

FIG. 2 is a diagram illustrating an example of a configuration of an in-vehicle apparatus according to the first embodiment of the present disclosure. Referring to FIG. 2, the in-vehicle apparatus 101 is connected, for example, to a plurality of in-vehicle devices 202 via a communication bus 51 and a connector 52. The in-vehicle apparatus 101 and the plurality of in-vehicle devices 202 constitute an in-vehicle network 401. The communication bus 51 is, for example, a CAN bus that conforms to the CAN (Controller Area Network) standard. The connector 52 is, for example, a connector that conforms to the OBD (On-Board Diagnostics) 2 standard. The communication bus 51 is an example of a communication line.

The in-vehicle devices 202 include, for example, in-vehicle ECUs such as a TCU (Telematics Communication Unit), an automatic driving ECU (Electronic Control Unit), a face recognition ECU, and a door lock ECU. Note that the in-vehicle devices 202 are not limited to such in-vehicle ECUs, but may be sensors, navigation devices, human machine interfaces, cameras, and the like.

In the example shown in FIG. 2, the in-vehicle apparatus 101 is connected to in-vehicle devices 202A and 202B, which are the in-vehicle devices 202, via a communication bus 51A, which is the communication bus 51, and a connector 52A, which is the connector 52. Also, the in-vehicle apparatus 101 is connected to in-vehicle devices 202C and 202D, which are the in-vehicle devices 202, via a communication bus 51B, which is the communication bus 51, and a connector 52B, which is the connector 52.

Each in-vehicle device 202 generates a frame that contains various types of information such as information to assist automatic driving performed by the vehicle 1 and information for use in entertainment, and an ID (Identifier) indicating the type of data, etc. (hereinafter also referred to as “data ID”). The in-vehicle device 202 then sends the generated frame to another in-vehicle device 202 directly or via a not-shown relay device in the vehicle 1.

Referring to FIGS. 1 and 2, the in-vehicle apparatus 101 sends, for example, transmission information sent on the communication bus 51 to the server 151 via the external network 161.

The transmission information contains device information relating to in-vehicle devices 202, for example. The device information includes log information in which data contained in frames received from the in-vehicle devices 202 is associated with the time of receipt of the frames, images captured by a camera in the vehicle 1, information acquired by external devices such as communication terminals, and the like.

The server 151 collects, for example, device information on the corresponding vehicle 1 from one or more in-vehicle apparatuses 101. The server 151 then detects abnormalities relating to the vehicle 1, such as malfunctions of the vehicle 1, based on the collected device information.

Note that the in-vehicle apparatuses 101 and the in-vehicle devices 202 may be configured to perform, instead of or in addition to communication conforming to the CAN standard, communication conforming to communication protocols such as CAN FD (CAN with Flexible Data Rate), Ethernet (registered trademark), FlexRay (registered trademark), MOST (Media Oritend System Transport) (registered trademark), LIN (Local Interconnect Network), and CXPI (Clock Extension Peripheral Interface) (registered trademark).

The in-vehicle apparatus 101 includes an internal communication unit 11, a setting processing unit 12, an external communication unit 13, and a storage unit 14. Some or all of the internal communication unit 11, the setting processing unit 12, the external communication unit 13 are realized, for example, by a processing circuitry including one or more processors. The storage unit 14 is, for example, a non-volatile memory included in the processing circuitry. The internal communication unit 11 is an example of an acquisition unit.

The internal communication unit 11 acquires vehicle information relating to the vehicle 1 from the communication bus 51 in the in-vehicle network 401. The vehicle information includes vehicle identification information (hereinafter referred to also as “vehicle ID”) for identifying the vehicle 1, product number information indicating the product numbers of software or the like of the in-vehicle devices 202, or the like. Here, the internal communication unit 11 acquires the vehicle ID as the vehicle information. The vehicle ID is a unique ID for each vehicle 1.

In more detail, for example, the internal communication unit 11 acquires the vehicle ID output to the communication bus 51 from the in-vehicle devices 202 connected to the communication bus 51.

Specifically, for example, the storage unit 14 stores an ID (hereinafter also referred to as “request ID”) whose transmission source is the corresponding in-vehicle apparatus 101 in accordance with the OBD2 standard and that indicates a request for a vehicle ID.

When the ignition power source of the vehicle 1 is switched from off to on and the corresponding in-vehicle apparatus 101 is activated, the internal communication unit 11 creates a frame (hereinafter also referred to as “ID request frame”) that contains the request ID stored in the storage unit 14 and outputs the created frame to the communication bus 51.

A not-shown storage unit provided in an in-vehicle device 202 stores a reception list indicating IDs contained in the frames to be received by the in-vehicle device 202. When the in-vehicle device 202 receives the ID request frame from the in-vehicle apparatus 101 via the communication bus 51 to which the in-vehicle device 202 is connected, the in-vehicle device 202 checks whether the request ID contained in the received ID request frame is registered in the reception list.

When the in-vehicle device 202 confirms that the request ID is registered in the reception list, the in-vehicle device 202 acquires the vehicle ID from the corresponding storage unit. The storage unit also stores an ID (hereinafter also referred to as “response ID”) indicating that the vehicle ID has been acquired according to the OBD2 standard.

After having acquired the vehicle ID, the in-vehicle device 202 creates a frame (hereinafter also referred to as “response frame”) including the acquired vehicle ID and the response ID stored in the storage unit as a response to the ID request frame, and outputs the created frame to the communication bus 51.

In the in-vehicle apparatus 101, upon receiving the response frame from the in-vehicle device 202 via the communication bus 51 and the connector 52, the internal communication unit 11 outputs the vehicle ID contained in the received response frame to the external communication unit 13.

The external communication unit 13 sends the vehicle ID acquired by the internal communication unit 11 to the server 151.

In more detail, the external communication unit 13 communicates with the server 151 via the external network 161 by performing wireless communication with an apparatus such as a not shown wireless base station in accordance with a communication method such as WiFi (registered trademark), LTE (Long Term Evolution) (registered trademark) or 5G. Note that the configuration of the external communication unit 13 is not limited to a configuration in which it communicates with the server 151 via the wireless base station and the external network 161, but may be a configuration in which it communicates with the server 151 via a wired line. Also, the external communication unit 13 may be configured to communicate with the server 151 via an additional in-vehicle apparatus.

Upon receiving the vehicle ID from the internal communication unit 11, the external communication unit 13 sends the vehicle ID to the server 151 via the wireless base station and the external network 161.

Specifically, for example, the external communication unit 13 creates an IP packet that contains the vehicle ID, as well as the IP addresses of the corresponding in-vehicle apparatus 101 and the server 151, which respectively serve as a transmission source address and a destination IP address. Then, the external communication unit 13 sends the created IP packet to the server 151 via the wireless base station and the external network 161.

### Server

FIG. 3 is a diagram illustrating an example of a configuration of a server according to the first embodiment of the present disclosure. Referring to FIG. 3, the server 151 includes a communication unit 21, a setting information determination unit 22, an analysis unit 23, and a storage unit 24. Some or all of the communication unit 21, the setting information determination unit 22, and the analysis unit 23 are realized, for example, by a processing circuitry including one or more processors. The storage unit 24 is, for example, a non-volatile memory included in the processing circuitry.

The communication unit 21 receives a vehicle ID from the in-vehicle apparatus 101. In more detail, upon receiving an IP packet containing a vehicle ID from the in-vehicle apparatus 101 via the wireless base station and the external network 161, the communication unit 21 outputs the vehicle ID contained in the received IP packet to the setting information determination unit 22.

The setting information determination unit 22 determines setting information that is based on the vehicle ID received by the communication unit 21 and indicates the setting content used for the in-vehicle apparatus 101 to communicate with the in-vehicle device 202.

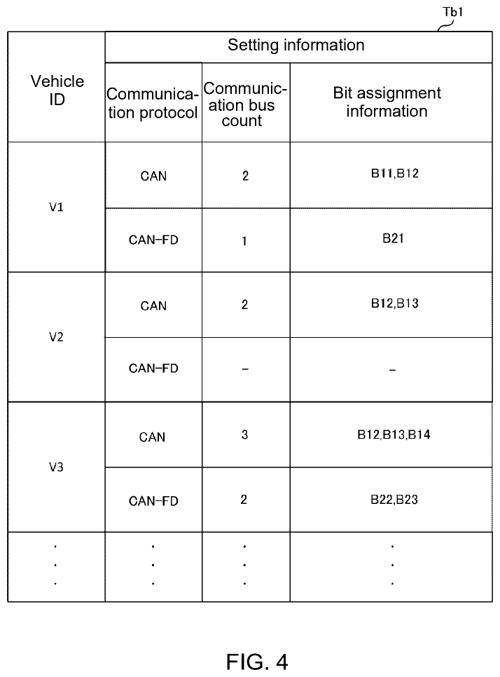

FIG. 4 is a diagram illustrating an example of a correspondence table stored in the server according to the first embodiment of the present disclosure.

Referring to FIGS. 3 and 4, for example, the storage unit 24 stores a correspondence table Tb1 that indicates the correspondence relationship between the vehicle ID and the setting information.

Specifically, in the correspondence table Tb1, the setting information indicates the communication protocols, the communication bus counts, and the bit assignment information numbers.

Referring to the correspondence table Tb1, in the vehicle 1 of the vehicle ID “V1”, the communication protocols “CAN” and “CAN FD” are used, there are two CAN buses, which are communication buses conforming to the “CAN” standard, and the bit assignment information numbers of the CAN buses are “B11 and B12”. Also, in the vehicle 1, there is one CAN-FD bus, which is a communication bus conforming to the “CAN FD” standard, and the bit assignment information number of the CAN-FD bus is “B21”.

In the vehicle 1 of the vehicle ID “V2”, the communication protocol “CAN” is used, there are two CAN buses conforming to the “CAN” standard, and the bit assignment information numbers of the CAN buses are “B12 and B13”. In the vehicle 1 of the vehicle ID “V2”, the communication protocol “CAN FD” is not used.

In the vehicle 1 of the vehicle ID “V3”, the communication protocols “CAN” and “CAN FD” are used, there are three CAN buses conforming to the “CAN” standard, and the bit assignment information numbers of the CAN buses are “B12, B13, and B14”. Also, in the vehicle 1, there are two CAN-FD buses, which are communication buses conforming to the “CAN FD” standard, and the bit assignment information numbers of the CAN-FD buses are “B22 and B23”.

Note that the setting information is not limited to the communication protocols, the communication bus counts, and the bit assignment information numbers, but may indicate the frame bit rate, data sampling points, or the like.

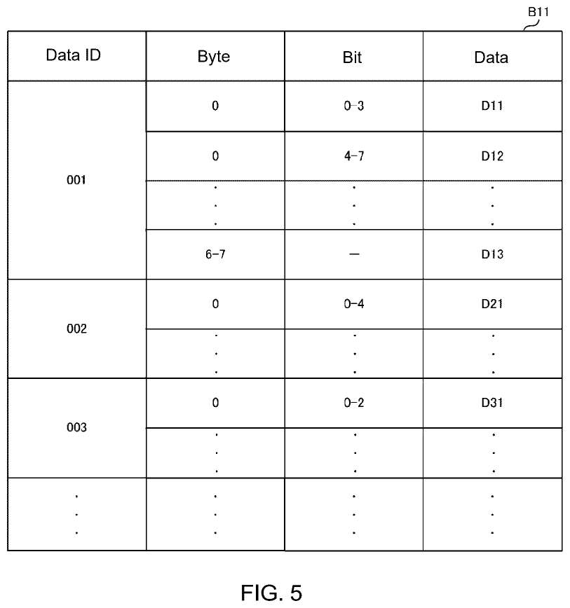

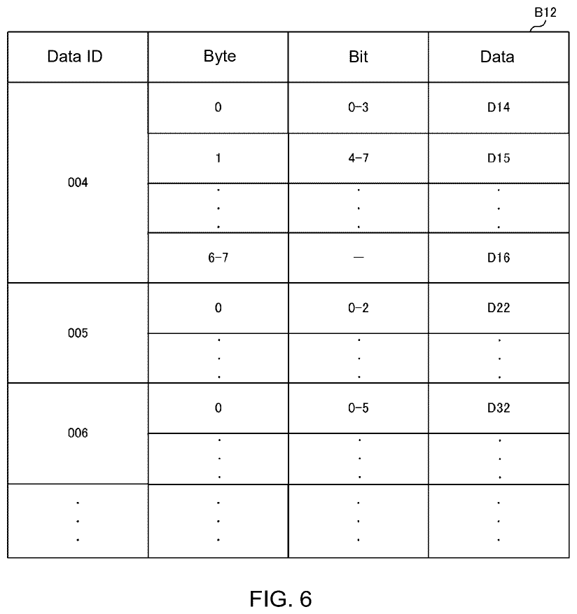

FIG. 5 is a diagram illustrating an example of bit assignment information stored in the server according to the first embodiment of the present disclosure. FIG. 6 is a diagram illustrating another example of bit assignment information stored in the server according to the first embodiment of the present disclosure. FIGS. 5 and 6 respectively show the bit assignment information B11 and the bit assignment information B12 in the correspondence table Tb1 shown in FIG. 4.

Referring to FIGS. 3, 5, and 6, the storage unit 24 further stores bit assignment information. The bit assignment information indicates the correspondence relationship between the data IDs and the positions of data in the data fields of frames.

Referring to the bit assignment information B11, in the data field of the frame containing the data ID “001”, 0th to 3rd bits of the 0th byte contain data D11, 4th to 7th bits of the Oth byte contain data D12, and 6th to 7th bytes contain data D13. In the data field of the frame containing the data ID “002”, 0th to 4th bits of the 0th byte contain data D21. In the data field of the frame containing the data ID “003”, 0th to 2nd bits of the 0th byte contain data D31.

Referring to the bit assignment information B12, in the data field of the frame containing the data ID “004”, 0th to 3rd bits of the 0th byte contain data D14, 4th to 7th bits of the 1st byte contain data D15, and 6th to 7th bytes contain data D16. In the data field of the frame containing the data ID “005”, 0th to 2nd bits of the 0th byte contain data D22. In the data field of the frame containing the data ID “006”, 0th to 5th bits of the 0th byte contain data D32.

Referring again to FIGS. 1 and 4, upon receiving the vehicle ID from the communication unit 21, the setting information determination unit 22 reads out the correspondence table Tb1 stored in the storage unit 24. Then, the setting information determination unit 22 checks setting information that corresponds to the vehicle ID with reference to the correspondence table Tb1

After having checked the setting information, the setting information determination unit 22 retrieves the bit assignment information of the number indicated by this setting information from the storage unit 24. Then, the setting information determination unit 22 sends a setting instruction including the setting information and the retrieved bit assignment information to the in-vehicle apparatus 101 via the communication unit 21.

Specifically, the setting information determination unit 22 outputs the setting instruction to the communication unit 21. Upon receiving the setting instruction from the setting information determination unit 22, the communication unit 21 creates an IP packet that contains the setting instruction, as well as the IP addresses of the corresponding server 151 and the in-vehicle apparatus 101, which respectively serve as a transmission source address and a destination IP address. Then, the communication unit 21 sends the created IP packet to the in-vehicle apparatus 101 via the wireless base station and the external network 161.

### Setting Processing

Referring again to FIG. 2, in the in-vehicle apparatus 101, the setting processing unit 12 performs setting processing for the corresponding in-vehicle apparatus 101 to communicate with an in-vehicle device 202 via the communication bus 51 using the setting information based on the vehicle information acquired by the internal communication unit 11.

In more detail, for example, upon receiving the IP packet containing the setting instruction from the server 151 via the wireless base station and the external network 161, the external communication unit 13 stores the setting instruction contained in the received IP packet in the storage unit 14 and outputs a reception notification indicating that the setting instruction has been received to the setting processing unit 12.

Upon receiving the reception notification from the external communication unit 13, the setting processing unit 12 refers to the setting instruction stored in the storage unit 14, and configures operation settings of the internal communication unit 11 by configuring register settings and the like in response to the setting instruction.

For example, the internal communication unit 11 acquires transmission information sent on the communication bus 51 in accordance with the above-described setting processing by the setting processing unit 12. Then, for example, the external communication unit 13 sends part or whole of the transmission information acquired by the internal communication unit 11 to the server 151.

### Example 1

The internal communication unit 11 on which the above-described operation settings were configured receives a frame from an in-vehicle device 202 sent on the communication bus 51, and reads out the bit assignment information corresponding to the communication bus 51 in the storage unit 14. The internal communication unit 11 then checks the bit assignment information to check the data contained in the frame.

The internal communication unit 11 creates log information in which the confirmed data is associated with the reception time of the frame containing the data, stores the created log information in the storage unit 14, and outputs a creation completion notification indicating that the log information has been created, to the external communication unit 13.

Upon receiving the creation completion notification from the internal communication unit 11, the external communication unit 13 retrieves the log information from the storage unit 14 and creates an IP packet that contains the log information, as well as the IP addresses of the corresponding in-vehicle apparatus 101 and the server 151, which respectively serve as a transmission source address and a destination IP address. Then, the external communication unit 13 sends the created IP packet to the server 151 via the wireless base station and the external network 161.

### Example 2

The internal communication unit 11 on which the above-described operation settings were configured receives a frame from an in-vehicle device 202 sent on the communication bus 51, and checks whether or not predetermined transmission target data to be sent to the server 151 is contained in the frame. For example, the transmission target data was registered in advance at the time of shipping the in-vehicle apparatus 101.

If the transmission target data is contained in the received frame, the internal communication unit 11 acquires the transmission target data from the frame and outputs it to the external communication unit 13.

Upon receiving the transmission target data from the internal communication unit 11, the external communication unit 13 creates an IP packet that contains the transmission target data, as well as the IP addresses of the corresponding in-vehicle apparatus 101 and the server 151, which respectively serve as a transmission source address and a destination IP address. Then, the external communication unit 13 sends the created IP packet to the server 151 via the wireless base station and the external network 161.

Note that, for example, if no new transmission information arrives from the in-vehicle device 202 even after the elapse of a certain period of time since the transmission information was acquired, the internal communication unit 11 may determine that the vehicle 1 in which the corresponding in-vehicle apparatus 101 is installed has changed. In this case, the internal communication unit 11 creates the above-described ID request frame to acquire a new vehicle ID.

### Analysis Processing

Referring again to FIG. 3, the server 151 performs analysis processing for analyzing the transmission information received from the in-vehicle apparatus 101.

In more detail, upon receiving the transmission information from the in-vehicle apparatus 101, the communication unit 21 of the server 151 outputs the received transmission information to the analysis unit 23.

Upon receiving the transmission information from the communication unit 21, the analysis unit 23 performs various types of analysis such as detection of abnormalities relating to the vehicle 1, based on this transmission information.

### Flow of Operation

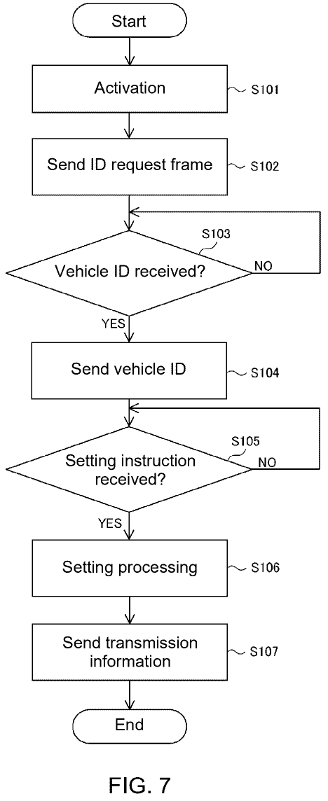

FIG. 7 is a flowchart that defines an operation procedure when the in-vehicle apparatus according to the first embodiment of the present disclosure performs setting processing.

Referring to FIG. 7, first, the in-vehicle apparatus 101 is activated when the ignition power source of the vehicle 1 is switched from off to on (step S101).

Then, the in-vehicle apparatus 101 sends, to an in-vehicle device 202, an ID request frame that contains a request ID indicating a request for a vehicle ID (step S102).

Then, if the in-vehicle apparatus 101 receives a vehicle ID from the in-vehicle device 202 (YES in step S103), the in-vehicle apparatus 101 sends the received vehicle ID to the server 151 (step S104).

Then, if the in-vehicle apparatus 101 receives a setting instruction from the server 151 (YES in step S105), in-vehicle apparatus 101 performs setting processing to communicate with the in-vehicle device 202 based on the setting information contained in the setting instruction (step S106).

The in-vehicle apparatus 101 sends transmission information sent on the communication bus 51 to the server 151 in accordance with the setting processing (step S107).

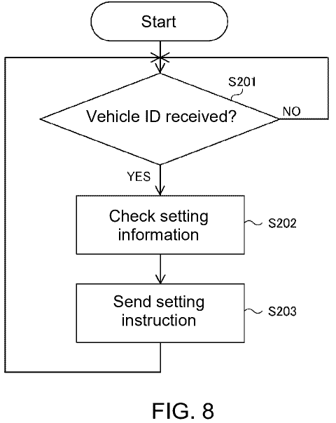

FIG. 8 is a flowchart that defines an operation procedure when the server according to the first embodiment of the present disclosure sends a setting instruction.

Referring to FIG. 8, first, the server 151 waits for receipt of a vehicle ID from the in-vehicle apparatus 101 (NO in step S201).

Then, if the server 151 receives the vehicle ID from the in-vehicle apparatus 101 (YES in step S201), the server 151 checks the setting information corresponding to this vehicle ID. For example, as described above, the server 151 refers to the correspondence table Tb1 in the storage unit 24 to check the setting information corresponding to the vehicle ID received from the in-vehicle apparatus 101 (step S202).

Then, the server 151 sends a setting instruction including the confirmed setting information and the bit assignment information of the number indicated by the setting information, to the in-vehicle apparatus 101. For example, as described above, after having checked the setting information corresponding to the received vehicle ID, the server 151 retrieves the bit assignment information of the number indicated by the setting information from the storage unit 24, sends the setting instruction including the setting information and the bit assignment information to the in-vehicle apparatus 101 (step S203), and waits for receipt of a new vehicle ID (step S201).

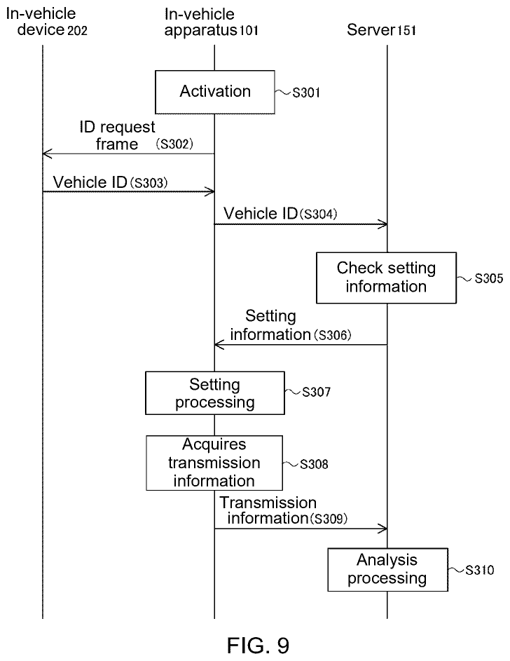

FIG. 9 is a diagram illustrating an example of a sequence of processes of the in-vehicle apparatus, the server, and an in-vehicle device in the communication system according to the first embodiment of the present disclosure.

Referring to FIG. 9, first, the in-vehicle apparatus 101 is activated when the ignition power source of the vehicle 1 is switched from off to on (step S301).

Then, the in-vehicle apparatus 101 sends, to the in-vehicle device 202, an ID request frame that contains a request ID indicating a request for a vehicle ID (step S302).

Then, the in-vehicle device 202 sends the vehicle ID to the in-vehicle apparatus 101. For example, as described above, the in-vehicle device 202 sends, to the in-vehicle apparatus 101, a response frame that contains the vehicle ID and a response ID indicating that the vehicle ID has been acquired (step S303).

Then, the in-vehicle apparatus 101 sends the vehicle ID received from the in-vehicle device 202 to the server 151 (step S304).

Then, when the server 151 checks the setting information that corresponds to the vehicle ID received from the in-vehicle apparatus 101. For example, as described above, the server 151 refers to the correspondence table Tb1 in the storage unit 24 to check the setting information corresponding to the vehicle ID received from the in-vehicle apparatus 101 (step S305).

Then, the server 151 sends, to the in-vehicle apparatus 101, a setting instruction including the confirmed setting information and the bit assignment information of the number indicated by the setting information. For example, as described above, after having checked the setting information corresponding to the received vehicle ID, the server 151 retrieves the bit assignment information of the number indicated by the setting information from the storage unit 24, and sends the setting instruction including the setting information and the bit assignment information to the in-vehicle apparatus 101 (step S306).

Then, the in-vehicle apparatus 101 performs setting processing based on the setting information contained in the setting instruction received from the server 151 (step S307).

Then, the in-vehicle apparatus 101 acquires the transmission information sent on the communication bus 51 in accordance with the setting processing (step S308).

Then, the in-vehicle apparatus 101 sends part or whole of the acquired transmission information to the server 151 (step S309).

Then, the server 151 performs analysis processing for analyzing the transmission information received from the in-vehicle apparatus 101. For example, as described above, the server 151 performs various types of analysis such as detection of abnormalities relating to the vehicle 1, based on this transmission information (step S310).

### Second Embodiment

In the above-described first embodiment of the present disclosure, the server 151 determines setting information that corresponds to a vehicle ID. In contrast, in a second embodiment of the present disclosure, an in-vehicle apparatus 101A determines setting information that corresponds to a vehicle ID. The in-vehicle apparatus 101A has the same configuration as the in-vehicle apparatus 101 according to the first embodiment, except for the content that will be described below.

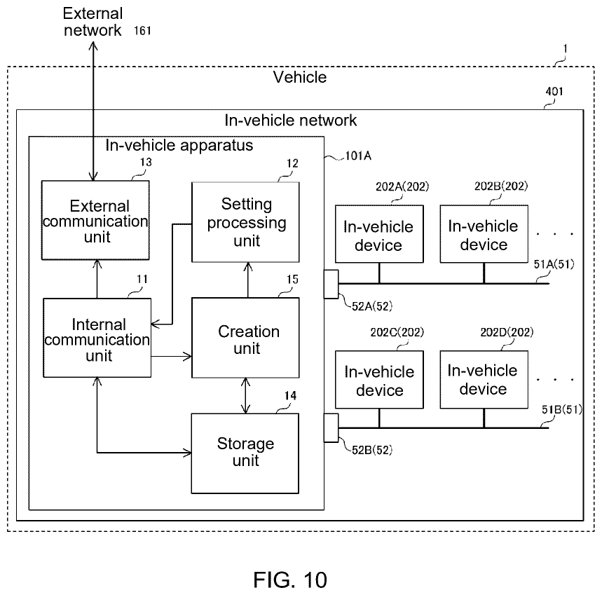

FIG. 10 is a diagram illustrating an example of a configuration of an in-vehicle apparatus according to the second embodiment of the present disclosure. Referring to FIG. 10, the in-vehicle apparatus 101A according to the second embodiment of the present disclosure further includes a creation unit 15, compared to the in-vehicle apparatus 101 shown in FIG. 2.

For example, the creation unit 15 creates setting information that corresponds to the vehicle 1 based on the vehicle ID acquired by the internal communication unit 11.

In more detail, for example, upon receiving a response frame from an in-vehicle device 202 via the communication bus 51 and the connector 52, the internal communication unit 11 outputs the vehicle ID contained in the received response frame to the creation unit 15.

The storage unit 14 stores, for example, the correspondence table Tb1 shown in FIG. 4. Upon receiving the vehicle ID from the internal communication unit 11, the creation unit 15 reads out the correspondence table Tb1 stored in the storage unit 14. Then, the creation unit 15 checks setting information that corresponds to the vehicle ID with reference to the correspondence table Tb1.

The storage unit 14 further stores bit assignment information in the correspondence table Tb1 shown in FIG. 4. The correspondence table Tb1 and the bit assignment information are registered in the storage unit 14 by the manufacturer of the vehicle 1 at the time of shipping the vehicle 1, for example.

After having checked the setting information, the creation unit 15 retrieves the bit assignment information of the number indicated by this setting information from the storage unit 14. Then, the creation unit 15 outputs a setting instruction including the setting information and the retrieved bit assignment information to the setting processing unit 12.

Upon receiving a setting instruction from the creation unit 15, the setting processing unit 12 configures operation settings of the internal communication unit 11 by configuring register settings and the like in response to the setting instruction.

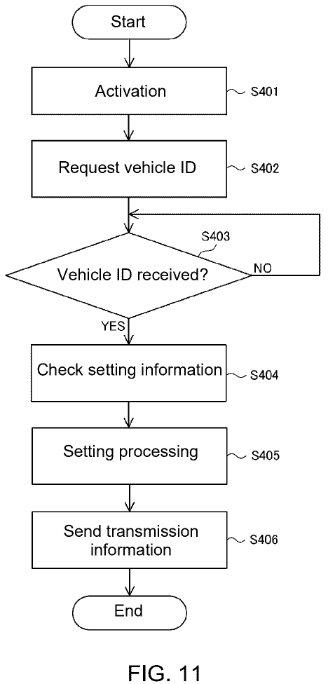

FIG. 11 is a flowchart that defines an operation procedure when the in-vehicle apparatus according to the second embodiment of the present disclosure performs setting processing.

Referring to FIG. 11, the processes in steps S401 and S402 are the same as the processes in steps S101 and S102 shown in FIG. 7.

Then, upon receiving the vehicle ID from the in-vehicle device 202 (YES in step S403), the in-vehicle apparatus 101A checks the setting information corresponding to the received vehicle ID. For example, as described above, the in-vehicle apparatus 101A refers to the correspondence table Tb1 in the storage unit 14 to check the setting information corresponding to the vehicle ID received from the in-vehicle device 202 (step S404).

Then, the in-vehicle apparatus 101A performs setting processing to communicate with the in-vehicle device 202 in accordance with the confirmed setting information and the bit assignment information of the number indicated by the setting information (step S405).

The process in step S406 is the same as the process in step S107 shown in FIG. 7.

### Third Embodiment

In the above-described first and second embodiments of the present disclosure, the in-vehicle apparatus 101 is connected to the in-vehicle devices 202 via the communication bus 51. Also, the in-vehicle apparatus 101 communicates with an in-vehicle device 202 in accordance with the OBD2 standard to acquire a vehicle ID from the in-vehicle device 202. In contrast, in a third embodiment of the present disclosure, the in-vehicle apparatus 101 is connected to an in-vehicle device 202 via Ethernet cable 53. Also, the in-vehicle apparatus 101 tries to communicate with an in-vehicle device 202 to acquire the vehicle ID from this in-vehicle device 202. The in-vehicle apparatus 101 has the same configuration as the in-vehicle apparatus 101 according to the first and second embodiments, except for the content that will be described below.

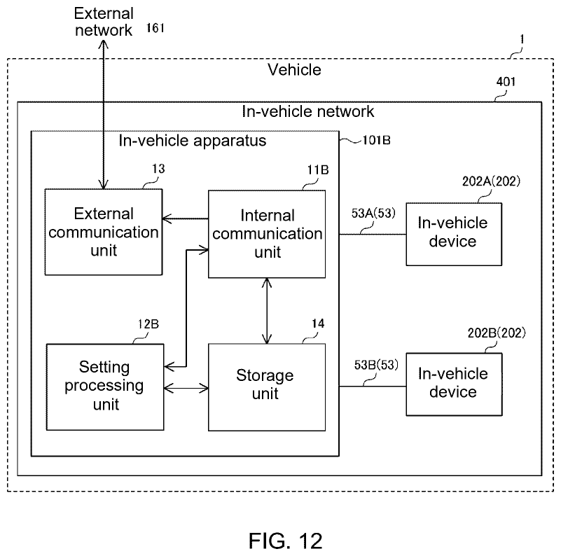

FIG. 12 is a diagram illustrating an example of a configuration of an in-vehicle apparatus according to the third embodiment of the present disclosure. Referring to FIG. 12, an in-vehicle apparatus 101B and a plurality of in-vehicle devices 202 constitute the in-vehicle network 401. The in-vehicle apparatus 101B is connected to the in-vehicle devices 202 via the Ethernet cable 53. The Ethernet cable 53 is an example of a communication line.

In the example shown in FIG. 12, the in-vehicle apparatus 101B is connected to an in-vehicle device 202A and an in-vehicle device 202B respectively via an Ethernet cable 53A and an Ethernet cable 53B, which serve as the Ethernet cable 53.

An Ethernet frame is used to exchange information between the in-vehicle apparatus 101B and the in-vehicle devices 202.

The in-vehicle apparatus 101B includes an internal communication unit 11B and a setting processing unit 12B, instead of the internal communication unit 11 and the setting processing unit 12 shown in FIG. 2.

For example, the setting processing unit 12B performs, prior to setting processing, trial processing to try to communicate with the in-vehicle devices 202 via the Ethernet cable 53, and changes the setting of the communication operation in the corresponding in-vehicle apparatus 101 based on the trial results until the trial results meet predetermined conditions.

In more detail, for example, if the corresponding in-vehicle apparatus 101B is retrofitted after the vehicle 1 has been shipped, the setting processing unit 12B tries to communicate with each of the in-vehicle devices 202 in the in-vehicle system 301 because the in-vehicle device 202 that stores the vehicle ID is unknown.

Specifically, for example, the storage unit 14 stores trial communication information that indicates the setting content for communicating with the in-vehicle devices 202 via the Ethernet cable 53. The trial communication information indicates, for example, the correspondence relationship between the bit rate of the Ethernet frame and the priority order.

Upon activation of the corresponding in-vehicle apparatus 101, the setting processing unit 12B configures operation settings of the internal communication unit 11B by configuring register settings and the like in accordance with the trial communication information in the storage unit 14. For example, the setting processing unit 12B sets the bit rate with the highest priority indicated by the trial communication information in the register setting, and performs the trial processing.

Upon receiving the Ethernet frame from an in-vehicle device 202, the internal communication unit 11B outputs the received Ethernet frame to the setting processing unit 12B.

Upon receiving the Ethernet frame from the internal communication unit 11B, the setting processing unit 12B performs check of CRC (Cyclic Redundancy Check) on the Ethernet frame.

Specifically, the setting processing unit 12B calculates the CRC value of the data contained in the Ethernet frame received from the internal communication unit 11B. Then, the setting processing unit 12B checks whether or not the calculated CRC value matches the FCS value contained in the FCS (Frame Check Sequence) field of the Ethernet frame.

If the CRC value matches the FCS value, the setting processing unit 12B determines that the data is normal and communication with the in-vehicle device 202 was successful, and outputs a communication success notification to the internal communication unit 11B.

For example, the internal communication unit 11B communicates with the in-vehicle device 202 in accordance with the settings of the communication operation that corresponds to the state where the trial results meet the predetermined conditions, and acquires the vehicle ID from the in-vehicle device 202.

In more detail, for example, upon receiving the communication success notification from the setting processing unit 12B, the internal communication unit 11B creates ID request information that indicates a request for a vehicle ID. Then, the internal communication unit 11B sends an Ethernet frame containing the created ID request information to each of the in-vehicle devices 202.

Upon receiving the Ethernet frame containing the ID request information from the in-vehicle apparatus 101, the in-vehicle device 202 checks whether or not any vehicle ID is stored in its storage unit.

If the vehicle ID is stored in the storage unit of the in-vehicle device 202, the in-vehicle device 202 creates an Ethernet frame containing this vehicle ID and sends the created Ethernet frame to the in-vehicle apparatus 101. On the other hand, if the vehicle ID is not stored in the storage unit of the in-vehicle device 202, the in-vehicle device 202 discards the Ethernet frame containing the ID request information received from the in-vehicle apparatus 101.

Upon receiving the Ethernet frame containing the vehicle ID from the in-vehicle device 202, the internal communication unit 11B of the in-vehicle apparatus 101 outputs this vehicle ID to the external communication unit 13.

On the other hand, if the CRC value do not match the FCS value, the setting processing unit 12B determines that the above-described data is abnormal and communication with the in-vehicle device 202 was failed. Then, the setting processing unit 12B discards the Ethernet frame received from the internal communication unit 11B.

Also, the setting processing unit 12B sets the bit rate with the next highest priority in the register setting with reference to the trial communication information in the storage unit 14, and continues the trial processing. Then, the setting processing unit 12B performs CRC check of the newly received Ethernet frame. The setting processing unit 12B repeats the trial processing until the CRC value and the FCS value match each other.

Note that, in the in-vehicle apparatus 101 according to the third embodiment of the present disclosure, the setting processing unit 12B is configured to perform trial processing if the corresponding in-vehicle apparatus 101 is connected to the in-vehicle devices 202 via the Ethernet cable 53, but the present disclosure is not limited to this. The setting processing unit 12B may be configured to perform trial processing if the corresponding in-vehicle apparatus 101 is connected to the in-vehicle devices 202 via the communication bus 51, as in the first and second embodiments of the present disclosure. In this case, the trial communication information in the storage unit 14 indicates, for example, the correspondence relationship between the bit rate of a CAN frame, the sampling points of data, and the priority order. The setting processing unit 12B changes the bit rate and the sampling points until it is determined in the CRC check that the data is normal.

The above-described embodiments are intended to be considered as examples in all respects and not restrictive. The scope of the present disclosure is indicated by the scope of the claims rather than the description above, and is intended to include all changes within the meaning and scope equivalent to the scope of the claims.

The processes (functions) of the above-described embodiments are realized by a processing circuitry that includes one or more processors. The processing circuitry may include, in addition to the one or more processors, an integrated circuit including a combination of one or more memories, various types of analog circuits, and various types of digital circuits, for example. The one or more memories store a program (instructions) that causes the one or more processors to execute the above-described processes. The one or more processors may execute the processes in accordance with the program read from the one or more memories, or may execute the processes in accordance with a logic circuit designed in advance to execute the processes. The processors may be any of various processors suitable for control of a computer, such as CPU (central processing unit), GPU (graphics processing unit), DSP (digital signal processor), FPGA (field programmable gate array), and ASIC (application specific integrated circuit). Note that the above-described physically separated processors may execute the processes in cooperation with each other. For example, the processors that are respectively installed in physically separated computers may execute the processes in cooperation with each other via a network such as LAN (local area network), WAN (wide area network), or the Internet. The program may be installed in the memory from an external server device or the like via the network, or may be distributed in a state of being stored in a recording medium such as CD-ROM (compact disc read only memory), DVD-ROM (digital versatile disk read only memory), or a semiconductor memory and installed in the memory from the recording medium.

The above description includes the following features.

### Supplementary Note 1

A management apparatus for use in a communication system provided with an in-vehicle apparatus, comprising: a receiving unit configured to receive vehicle information relating to a vehicle in which the in-vehicle apparatus is installed from the in-vehicle apparatus; and a setting information determination unit configured to send, to the in-vehicle apparatus, setting information that is based on the vehicle information received by the receiving unit and indicates setting content with which the in-vehicle apparatus communicates with another device.

### Supplementary Note 2

A communication system comprising: an in-vehicle apparatus for use in an in-vehicle network; and a management apparatus, wherein the in-vehicle apparatus is configured to send, to the management apparatus, vehicle information that relates to a vehicle in which the in-vehicle apparatus is installed and was acquired from a communication line in the in-vehicle network, and the management apparatus is configured to receive the vehicle information from the in-vehicle apparatus, and send, to the in-vehicle apparatus, setting information that is based on the vehicle information and indicates setting content with which the in-vehicle apparatus communicates with another device.

### Supplementary Note 3

A management method performed in a management apparatus for use in a communication system provided with an in-vehicle apparatus, the method comprising: a step of receiving vehicle information relating to a vehicle in which the in-vehicle apparatus is installed from the in-vehicle apparatus; and a step of sending, to the in-vehicle apparatus, setting information that is based on the received vehicle information and indicates setting content with which the in-vehicle apparatus communicates with another device.

### Supplementary Note 4

A management program for use in a management apparatus used in a communication system provided with an in-vehicle apparatus, the program causing a computer to function as: a receiving unit configured to receive vehicle information relating to a vehicle in which the in-vehicle apparatus is installed from the in-vehicle apparatus; and a setting information determination unit configured to send, to the in-vehicle apparatus, setting information that is based on the vehicle information received by the receiving unit and indicates setting content with which the in-vehicle apparatus communicates with another device.

### Supplementary Note 5

A setting processing method performed in a communication system provided with an in-vehicle apparatus for use in an in-vehicle network and a management apparatus, the method comprising: a step of the in-vehicle apparatus sending, to the management apparatus, vehicle information that relates to a vehicle in which the in-vehicle apparatus is installed and was acquired from a communication line in the in-vehicle network; and a step of the management apparatus receiving the vehicle information from the in-vehicle apparatus, and sending, to the in-vehicle apparatus, setting information that is based on the vehicle information and indicates setting content with which the in-vehicle apparatus communicates with another device.

### Supplementary Note 6

An in-vehicle apparatus for use in an in-vehicle network, comprising: a processing circuitry, wherein the processing circuitry is configured to acquire vehicle information that relates to a vehicle in which the in-vehicle apparatus is installed from a communication line in the in-vehicle network, and perform setting processing that allows the in-vehicle apparatus to communicate with another device via the communication line, using setting information based on the acquired vehicle information.

1-8. (canceled)

9. An in-vehicle apparatus for use in an in-vehicle network, comprising:
an acquisition unit configured to acquire vehicle information relating to a vehicle in which the in-vehicle apparatus is installed from a communication line in the in-vehicle network; and
a setting processing unit configured to perform setting processing that allows the in-vehicle apparatus to communicate with another device via the communication line using setting information based on the vehicle information acquired by the acquisition unit.

10. The in-vehicle apparatus according to claim 1,
wherein the communication line is a communication bus, and
the acquisition unit acquires the vehicle information output to the communication bus from an in-vehicle device connected to the communication bus.

11. The in-vehicle apparatus according to claim 1, further including;
a communication unit configured to send the vehicle information acquired by the acquisition unit to a management apparatus located outside the vehicle, and receive the setting information from the management apparatus,
wherein the setting processing unit performs the setting processing based on the setting information received by the communication unit.

12. The in-vehicle apparatus according to claim 1,
wherein, prior to the setting processing, the setting processing unit performs a trial to communicate with the other device via the communication line, and changes settings of communication operation in the in-vehicle apparatus based on trial results of the trial until the trial results meet predetermined conditions, and
the acquisition unit communicates with the other device in accordance with the settings that correspond to a state where the trial results meet the predetermined conditions.

13. The in-vehicle apparatus according to claim 1, further including;
a creation unit configured to create the setting information that corresponds to the vehicle based on the vehicle information acquired by the acquisition unit.

14. The in-vehicle apparatus according to claim 1,
wherein the acquisition unit is further configured to acquire transmission information sent in the communication line in accordance with the setting processing, and
the in-vehicle apparatus further comprises:
a communication unit configured to send the transmission information acquired by the acquisition unit to an external apparatus located outside the vehicle.

15. The in-vehicle apparatus according to claim 11,
wherein the vehicle information is vehicle identification information for identifying the vehicle,
the acquisition unit determines whether or not the vehicle in which the in-vehicle apparatus is installed has changed, and in a case of determining that the vehicle has changed, the acquisition unit newly acquires vehicle identification information,
the communication unit sends the vehicle identification information newly acquired by the acquisition unit to the management apparatus, and receives new setting information from the management apparatus, and
the setting processing unit performs the setting processing based on the new setting information received by the communication unit.

16. A setting processing method performed in an in-vehicle apparatus that is used in an in-vehicle network, comprising:
a step of acquiring vehicle information relating to a vehicle in which the in-vehicle apparatus is installed from a communication line in the in-vehicle network; and
a step of performing setting processing that allows the in-vehicle apparatus to communicate with another device via the communication line using setting information based on the acquired vehicle information.

17. A setting processing program for use in an in-vehicle apparatus that is used in an in-vehicle network,
the program causing a computer to function as:
an acquisition unit configured to acquire vehicle information relating to a vehicle in which the in-vehicle apparatus is installed from a communication line in the in-vehicle network;
a setting processing unit configured to perform setting processing that allows the in-vehicle apparatus to communicate with another device via the communication line using setting information based on the vehicle information acquired by the acquisition unit.
